(19) United States
(12) Patent Application Publication
(10) Pub. No.: US 2007/0094845 A1
(43) Pub. Date: May 3, 2007

(54) [HINGE]

(75) Inventors: Chi-Pu Chang, TAIPEI (TW); Chung-Chi Kuo, TAIPEI (TW)

Correspondence Address: BIRCH STEWART KOLASCH & BIRCH, PO BOX 747, FALLS CHURCH, VA, 22040-0747, US

(73) Assignee: CHECHU TECH. ENTERPRISE CO., LTD., Lu-Chou City, Taipei Hsien (TW)

(21) Appl. No.: 11/163,856

(22) Filed: Nov. 1, 2005

(51) Int. Cl. E05D 11/08

(52) U.S. Cl. 16/342

(57) ABSTRACT

A hinge includes a housing member, a mounting member, a pivot shaft, which has a first connecting portion pivotally coupled to the housing member and a second connecting portion affixed to the mounting member, and a friction spring washer set mounted on the pivot shaft and secured to the housing member, each friction spring washer having a peripheral deformable portion and a peripheral notch in the peripheral deformable portion for releasing torque produced against the friction spring washers during rotary motion of the pivot shaft with the mounting member relative to the housing member.

### BACKGROUND OF THE INVENTION

1. Field of the Invention

The present invention relates to hinges and more particularly, to a durable hinge, which has means to release the torque from the friction spring washers during the operation, preventing damage to the friction spring washers.

2. Description of the Related Art

In a vehicle rearview mirror, notebook computer, electronic dictionary, PDA, or any of a variety of two-leaf type electronic devices, a hinge is used to let two parts be turnable relative to each other and then quickly positioned in the desired position.

A conventional hinge is known comprising a pivot shaft and a set of washers. The pivot shaft uses the torque between the rotor and the stator to overcome the gravity weight of the supported member, for example, the cover of a notebook computer. The torque must be properly controlled. An excessively high torque causes the user unable to turn the supported part smoothly. An excessively low torque causes the pivot shaft unable to support the supported member in position. This torque has a great concern with the fabrication precision as well as the structural design of the hinge.

A hinge design is disclosed. According to this design, as shown in FIG. 8, the hinge comprises a first mounting member D, a second mounting member C, a pivot shaft A, which has a first end pivotally coupled to the first mounting member D and a second end longitudinally ribbed and coupled to the longitudinally grooved coupling hole (not shown) at the second mounting member C, and a washer set B mounted on the pivot shaft A and firmly positioned in the first mounting member D. Each washer B1 has a center axle hole B2 for the passing of the pivot shaft A, a slot B4, a passage B3 in communication between the slot B4 and the center axle hole B2, two friction arms B5 bilaterally suspending between the slot B4 and the center axle hole B2, and an inside notch B6 in communication with the center axle hole B2 at one side opposite to the passage B3. The slot B4, the passage B3, the axle hole B2 and the inside notch B6 form a lubricating oil space for receiving a lubricating oil to prevent breaking of the washers B1 during rotary motion of the pivot shaft A relative to the washers B1 and the first mounting member D.

This design of hinge is still not satisfactory in function because of the following drawbacks.

1. The torque produced during rotary motion of the pivot shaft A is distributed radially outwards through the washers Bi, at this time, the lower part of each washer B1 receives a great portion of the torque, therefore the lower part of each washer B1 may break easily.

2. Each washer B1 has an inside notch B6 for receiving the lubricating oil. Actually, this inside notch B6 is not necessary. When the pivot shaft A is turning upwards, a gap will be produced between the bottom side of the pivot shaft A and each washer B1 in the center axle hole B2 of each washer B1 for receiving the lubricating oil. An excessive mount of the lubricating oil may be accumulated in the inside notch B6 and the lower part of the center axle hole B2 of each washer B1, causing the pivot shaft A to displace from the expected position.

3. Further, because the second end of the pivot shaft A is longitudinally ribbed and coupled to the longitudinally grooved coupling hole at the second mounting member C, the second mounting member C may be forced away from the second end of the pivot shaft A accidentally.

Therefore, it is desired to provide a hinge that eliminates the aforesaid drawbacks.

### SUMMARY OF THE INVENTION

The present invention has been accomplished under the circumstances in view. It is the main object of the present invention to provide to a hinge, which is durable in use. To achieve this and other objects of the present invention, the hinge comprises a first housing member, a mounting member, a pivot shaft, which has a first connecting portion pivotally coupled to the housing member and a second connecting portion affixed to the mounting member, and a friction spring washer set mounted on the pivot shaft and secured to the housing member, wherein each friction spring washer has a peripheral deformable portion and a peripheral notch in the peripheral deformable portion for releasing torque produced against the friction spring washers during rotary motion of the pivot shaft with the mounting member relative to the housing member.

### BRIEF DESCRIPTION OF THE DRAWINGS

FIG. 1 is an elevational assembly view of a hinge according to the present invention.

FIG. 2 is an exploded view of the hinge according to the present invention.

FIG. 3 is an exploded view of a part of the hinge according to the present invention.

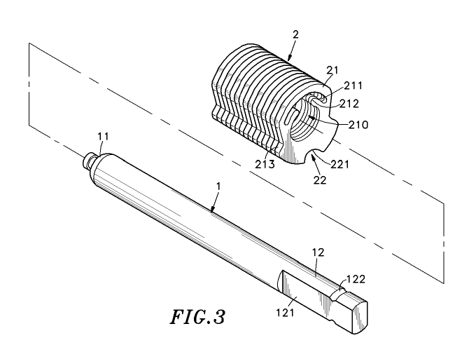

FIG. 4 is a front plain view of the present invention before rotary motion of the pivot shaft.

FIG. 5 is similar to FIG. 4 but showing the pivot shaft rotated.

FIG. 6 is an exploded view of an alternate form of the hinge according to the present invention.

FIG. 7 is an elevational view in an enlarged scale of one friction spring washer of the friction spring washer set shown in FIG. 6.

FIG. 8 is an exploded view of a hinge according to the prior art.

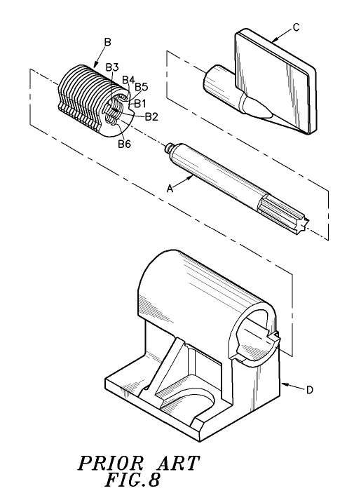

### DETAILED DESCRIPTION OF THE PREFERRED EMBODIMENT

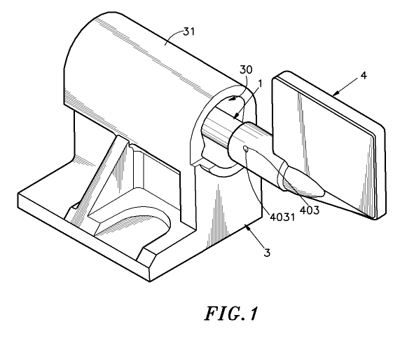

Referring to FIGS. 1˜3, a hinge in accordance with the present invention is shown comprised of a pivot shaft 1, a friction spring washer set 2, a housing member 3, and a mounting member 4.

The pivot shaft 1 has a first connecting portion 11 and a second connecting portion 12 respectively disposed at the two distal ends thereof. The second connecting portion 12 has two longitudinal cut planes 121 arranged in parallel at two opposite sides, and a locating groove 122 extending around the periphery across the cut planes 121.

The friction spring washer set 2 is comprised of a set of identical friction spring washers 21. The contour of the friction spring washers 21 shows a substantially circular shape. Each friction spring washer 21 has a center axle hole 210 for accommodating lubricating oil and for the passing of the pivot shaft 1, a smoothly arched slot 211 spaced around the center axle hole 210 for accommodating lubricating oil and having a middle part in communication with the center axle hole 210, two friction arms 212 bilaterally suspending between the smoothly arched slot 211 and the center axle hole 210, a deformable portion 22 formed of a part of the border area remote from the smoothly arched slot 211, a peripheral notch 221 formed in the deformable portion 22, and two shoulders 213 bilaterally spaced between the smoothly arched slot 211 and the deformable portion 22.

The housing member 3 has a barrel 31 disposed at one side. The barrel 31 defines a receiving chamber 30.

The mounting member 4 comprises a socket 40 disposed at one side for receiving the second connecting portion 12 of the pivot shaft 1, two locating flanges 401 symmetrically disposed at two opposite sides inside the socket 40, an inside locating rib 402 disposed inside the socket 40 and adapted to engage the locating groove 122, a radial through hole 403 radially cut through the peripheral wall of the socket 40, and a locating pin 4031 inserted into the radial through hole 403.

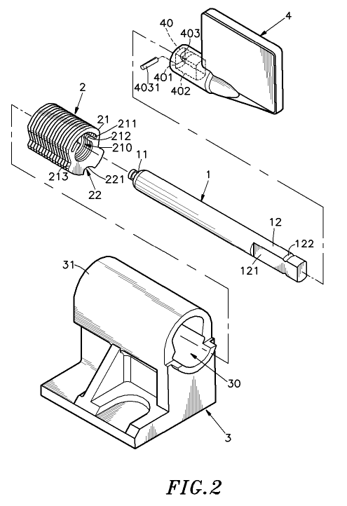

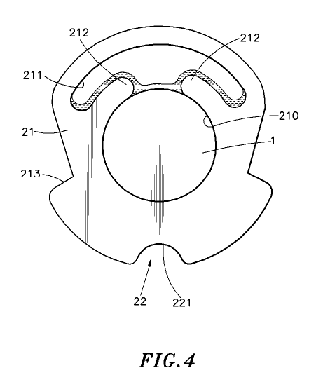

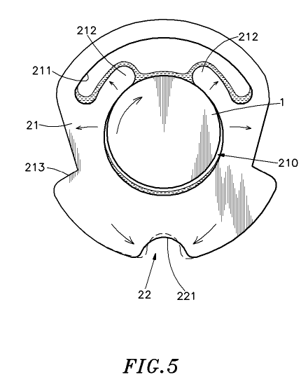

The assembly process of the present invention is simple and outlined hereinafter with reference to FIGS. 4 and 5 and FIG. 2 again. The pivot shaft 1 is inserted through the center axle hole 210 of each of the friction spring washers 21 to have the first connecting portion 11 be exposed to the outside of the friction spring washer set 2, and then the first connecting portion 11 of the pivot shaft 1 is inserted with the friction spring washer set 2 into the inside of the receiving chamber 30 of the barrel 31 of the housing member 3, and then the first connecting portion 11 of the pivot shaft 1 is pivotally coupled to a part of the inside of the receiving chamber 30 of the barrel 31 of the housing member 3, and then the second connecting portion 12 of the pivot shaft 1 is inserted into the socket 40 to attach the two cut planes 121 to the locating flanges 401 to further prohibit rotation of the pivot shaft 1 relative to the mounting member 4 and simultaneously to force the locating groove 122 into engagement with the locating rib 402 in the socket 40, and then the locating pin 4031 which is mounted in the radial through hole 403 is forced into the locating groove 122 to stop axial movement of the pivot shaft 1 relative to the mounting member 4. When the hinge is assembled, lubricating oil is filled into the smoothly arched slot 211 of each of the friction spring washers 21, and then rotate the mounting member 4 and the pivot shaft 1 relative to the housing member 3 to let lubricating oil flow downward from the smoothly arched slot 211 of each friction spring washer 21 to the bottom side of the center axle hole 210 of each friction spring washer 21 to lubricate the whole friction spring washer set 2 so as to reduce torque between the mounting member 4 and the friction spring washer set 2 when rotating the mounting member 4 and the pivot shaft 1 relative to the housing member 3.

During rotary motion of the pivot shaft 1 relative to the housing member 3, a torque is produced against the friction spring washer set 2. At this time, the deformable portion 22 of each friction spring washer 21 is deformed to release the torque through the peripheral notch 221 of each friction spring washer 21, preventing breaking of the friction spring washers 21.

Further, then amount of the friction spring washers 21 of the friction spring washer set 2 is determined subject to the desired torque, i.e., the amount of the friction spring washers 21 is relatively increased when a relatively higher torque is required, and the amount of the friction spring washers 21 is relatively reduced when a relatively lower torque is required.

Further, the aforesaid deformation portion 22 of each friction spring washer 21 and the peripheral notch 221 in the deformation portion 22 are designed to release the torque produced upon rotary motion of the shaft 1, they can be made in any shape and form capable of releasing the torque produced against the friction spring washer set 2 during rotary motion the pivot shaft 1 with the mounting member 4.

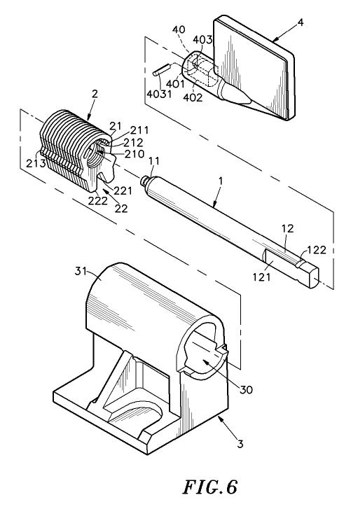

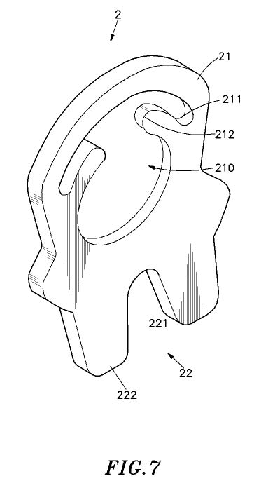

FIGS. 6 and 7 show an alternate form of the hinge according to the present invention. Each friction spring washer 21 of the friction spring washer set 2 according to this second embodiment is substantially similar to the aforesaid first embodiment with the exception that the deformable portion 22 defines two extensions 222 separated by the peripheral notch 221. When the friction spring washers 21 are twisted upon rotation of the pivot shaft 1, the peripheral notch 221 and the two extensions 222 allow the deformable portion 22 of the respective friction spring washer 21 to be temporarily deformed through at a relatively greater extent against the twisting force from the pivot shaft 1, preventing breaking of the friction spring washers 21 and extending the service life of the friction spring washers 21.

As indicated above, the hinge of the present invention has the following characteristics.

1. The torque produced during rotary motion of the pivot shaft 1 is distributed spirally outwards through the inner diameter each friction spring washer 21 toward the border area of each friction spring washer 21 and the bottom side of each friction spring washer 21, and the deformable portion 22 of each friction spring washer 21 is deformed to release the torque through the peripheral notch 221 of each friction spring washer 21, and therefore the friction spring washers 21 do not break and are durable in use.

2. When the friction spring washers 21 are squeezed by the torque produced during rotary motion of the pivot shaft 1, lubricating oil is forced to permeate downwards from the smoothly arched slot 211 of each friction spring washer 21 into the gap in the bottom side of the center axle hole 210 between the pivot shaft 1 and each friction spring washer 21, and therefore the friction spring washers 21 are constantly well lubricated.

3. The engagement between the locating flanges 401 and the cut planes 121 prevent rotary motion of the pivot shaft 1 relative to the mounting member 4; the engagement between the locating rib 402 and the locating groove 122 and the engagement between the locating pin 4031 and the locating groove 122 prevent axial movement of the pivot shaft 1 relative to the mounting member 4.

Although a particular embodiment of the invention has been described in detail for purposes of illustration, various modifications and enhancements may be made without departing from the spirit and scope of the invention.

1. A hinge comprising:
a housing member, said housing member having a barrel at one side thereof;
a mounting member, said mounting member having a socket at one side thereof;
a pivot shaft, said pivot shaft having a first connecting portion inserted into said barrel and pivotally coupled to said housing member and a second connecting portion fastened to said socket for allowing movement of said pivot shaft with said mounting member relative to said housing member; and
a friction spring washer set having a plurality of friction spring washers mounted on said pivot shaft and stopped inside said barrel of said housing member;
wherein each friction spring washer of said friction spring washer set is identical, each friction spring washer having a center axle hole for the passing of said pivot shaft, a smoothly arched slot extending continuously above and to each side of said center axle hole and disposed in communication with said center axle hole for accommodating lubricating oil, two friction arms bilaterally suspending between said smoothly arched slot and said center axle hole, a deformable portion formed of a peripheral part thereof remote from said smoothly arched slot, and a peripheral notch formed in said deformable portion.

2. The hinge according to claim 1, wherein said smoothly arched slot is centered above a center of said central axle hole.

3. The hinge according to claim 1, wherein the second connecting portion has two longitudinal cut planes arranged in parallel at two opposite sides.

4. The hinge according to claim 3, further comprising a locating groove extending around the periphery of said pivot shaft across the cut planes.

5. The hinge according to claim 4, further comprising a locating pin placed in said locating groove to prevent axial movement of the pivot shaft.

6. The hinge according to claim 1, wherein the peripheral notch defines two extensions.
